(19) United States
(12) Patent Application Publication
(10) Pub. No.: US 2025/0094173 A1
(43) Pub. Date: Mar. 20, 2025

(54) PROCESSOR WITH OUT-OF-ORDER COMPLETION

(71) Applicant: Apple Inc., Cupertino, CA (US)

(72) Inventor: Alon YAAKOV, Raanana (IL)

(21) Appl. No.: 18/493,750

(22) Filed: Oct. 24, 2023

Related U.S. Application Data
(60) Provisional application No. 63/582,626, filed on Sep. 14, 2023.

(51) Int. Cl. G06F 9/38; G06F 9/30

(52) U.S. Cl. CPC G06F 9/3836; G06F 9/30196

(57) ABSTRACT

A processor circuit that allows for out-of-order completion of instructions is disclosed. A processor circuit may fetch multiple instructions from a memory circuit. As individual instructions are fetched, the processor circuits checks for any hazards associated with the fetched instructions. Once it has been determined that there are no hazards for a particular instruction, it is issued to one of multiple execution circuits in the processor circuit. The processor circuit can complete instructions in an order in which the instructions finish execution by updating its architectural state with corresponding results of the instructions.

### CROSS-REFERENCE TO RELATED APPLICATIONS

The present application claims the benefit of U.S. Provisional Application No. 63/582,626, entitled “PROCESSOR WITH OUT-OF-ORDER COMPLETION,” filed Sep. 14, 2023, the content of which is incorporated by reference herein in its entirety for all purposes.

### FIELD

The described embodiments relate generally to computer systems and, more particularly, to completion of instructions in processor circuits.

### BACKGROUND

Modern computer systems may include multiple circuit blocks designed to perform various functions. For example, such circuit blocks may include processors or processor cores, memory circuits, mixed-signal circuits, analog circuits, and the like.

In some computer systems, memory circuits may be used to store instructions included in a software program or application. Processors or processor cores may retrieve such instructions from associated memory circuits in order to execute the instructions. Instructions may be retrieved by a processor or processor core according to how the instructions are arranged in the software program or application. Such an order can be referred to as “program order.” As the instructions are retrieved, the instructions may be executed in program order, or they may be executed in a different order than which they were fetched (referred to as “out-of-order execution”) to improve utilization of the circuits in a processor or processor core.

### BRIEF DESCRIPTION OF THE DRAWINGS

FIG. 1 is a block diagram depicting an embodiment of a computer system.

FIG. 2 is a block diagram depicting an embodiment of a processor circuit.

FIG. 3 is a block diagram depicting an embodiment of an execution circuit.

FIG. 4 is a diagram depicting execution of different instructions across different execution sub-circuits.

FIG. 5 is a flow diagram depicting an embodiment of a method for executing instructions in a processor with out-of-order completion.

FIG. 6 is a block diagram of an embodiment of a device that includes a processor trace system.

FIG. 7 is a block diagram of various embodiments of computer systems that may include power management circuits.

FIG. 8 illustrates an example of a non-transitory computer-readable storage medium that stores circuit design information.

### DETAILED DESCRIPTION

To execute a software program or application, a processor circuit fetches instructions in program order from a memory circuit that is storing the software program or application. In general, program order refers to the sequential order in which instructions appear in the software program or application. Conditional instructions can cause a jump to a different portion of the program (referred to as a “branch”). When a new branch is encountered, the processor circuit continues to fetch instructions in a sequential fashion within the branch until a new branch is detected, or a return to a previous branch or the main program line is indicated.

Once an instruction has been fetched from the memory circuit, it can be executed. In some cases, the processor circuit may execute instructions in an order in which they were fetched. When instructions are executed in this fashion, the structure of the software program or application can result in hardware resources within the processor circuit (e.g., execution circuits) being underutilized, resulting in inefficient execution of the software program or application.

Some processor circuits examine multiple instructions in order to schedule which instructions should be issued. In some cases, there are instructions that can be executed out-of-order relative to the order in which the instructions were fetched in a procedure referred to as “out-of-order execution.” For example, instructions whose operands have already been loaded can be issued before a previously fetched instruction that is still waiting on a load of its operands.

When instructions are executed out-of-order, care must be exercised as to when the architectural state of a processor circuit is updated with results from the executed instructions. For example, an instruction that involves a read of a particular register needs to be checked to make sure any instructions that write to the particular register which occur before the read instruction in the software program or application have completed. To accomplish this, processor circuits often employ a reorder buffer that stores results along with information pertaining to corresponding instructions. The reorder buffer then completes, i.e., updates the architectural state of processor circuit, the stored instructions in an order that avoids corrupting the architectural state of the processor circuit.

While executing instructions out-of-order, reorder buffers can, however, be costly in terms of area and power. In some mobile applications, having a reorder buffer can consume part of the overall power budget limiting the power consumption of other circuit blocks within the computer system.

The embodiments illustrated in the drawings and described below provide techniques for a processor circuit to schedule instructions to be issued in such a way that results of instructions can be used to update the architectural state of the processor circuit once the instructions have finished executing in a process referred to a “out-of-order completion.” By employing out-of-order completion of instructions, there is no longer a need for a reorder buffer, which can result in savings in area as well as power consumption in the processor circuit.

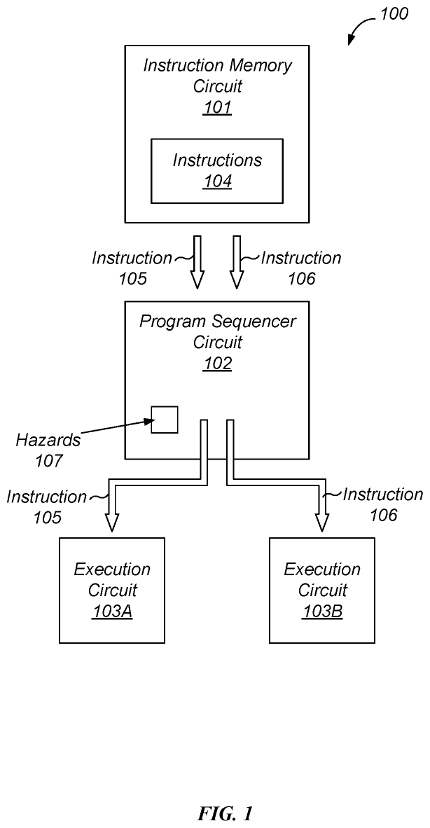

A block diagram of an embodiment of a computer system is depicted in FIG. 1. As illustrated, computer system 100 includes instruction memory circuit 101, program sequencer circuit 102, and execution circuits 103A and 103B. As described below, program sequencer circuit 102 and execution circuits 103A and 103B may be included in a processor or processor core.

Instruction memory circuit 101 is configured to store instructions 104. In various embodiments, instructions 104 may be included in a software program or application, and may be stored in instruction memory circuit 101 such that a particular address location within instruction memory circuit 101 stores a corresponding instruction of instructions 104. In some embodiments, instruction memory circuit 101 may be implemented as a dynamic random-access memory (DRAM) circuit, a static random-access memory (SRAM) circuit, or any other suitable memory circuit.

Program sequencer circuit 102 is configured to fetch (or “retrieve”) instructions 104 from instruction memory circuit 101 in a program order. In various embodiments, the program order is an order in which the instructions sequentially appear in the software program or application. For example, program sequencer circuit 102 may be configured to fetch instruction 105 from instruction memory circuit 101. After instruction 105 has been fetched, program sequencer circuit 102 may be configured to fetch the next instruction in program order, namely instruction 106. To fetch instructions 104, program sequencer circuit 102 may use a counter circuit configured to generate addresses to access instruction memory circuit 101.

Program sequencer circuit 102 is configured to issue instruction 105 to execution circuit 103A in response to a determination that instruction 105 has no pending hazards 107 from hazards 107. At a later time, program sequencer circuit 102 is configured to issue instruction 106 to execution circuit 103B in response to a determination there are no pending hazards 107 for instruction 106.

Hazards 107 can, in various embodiments, include both resource hazards and inter-pipe data hazards. Resource hazards can include unit resource hazards where an issuing instruction targets an active execution circuit, read port hazards, and write port hazards where the issuing instruction will reach its writeback stage at the same time another instruction is writing to the same register. Inter-pipe data hazards include read-after-write hazards, where the issuing instruction reads from a register that a previously issued instruction which is further down a processing pipeline writes to the same register, along with write-after-write hazards, and write-after-read hazards. In some cases, hazards 107 can include control hazards where the execution of a given instruction may depend on whether an earlier branch was taken or not taken.

Execution circuit 103A is configured to execute instruction 105, and execution circuit 103B is configured to execute instruction 106. As described below, execution circuits 103A and 103B may include multiple execution sub-circuits arranged in respective pipeline stages. In various embodiments, execution circuit 103B is configured to complete instruction 106 prior to execution circuit 103A completing instruction 105. As used herein, completion (also referred to as “retirement”) of an instruction refers to when a result of the instruction is used to update the architectural state of the processor circuit that includes program sequencer circuit 102 and execution circuits 103A and 103B. Once the architectural state of the processor circuit has been updated, the result is available to a software program or application being run on the processor circuit. It is noted that when execution of an instruction has been completed, a result of the instruction may be used within the processor circuit, but until the additional step of completing (or retiring) the instruction has been performed, the result of the instruction is not available to a software program or application run on the processor circuit.

Since instruction 106 is completed before instruction 105, the two instructions are said to be completed “out-of-order.” By employing program sequencer circuit 102 to perform a hazard check on an instruction before issuing, by the time a result of the instruction is ready, it can be used in the next cycle to update the architectural state of the processor circuit rather than temporarily saving the result in a reorder buffer until it is safe to update the architectural state. Since a reorder buffer is not required, both area and power consumption of the processor circuit may be reduced in some embodiments.

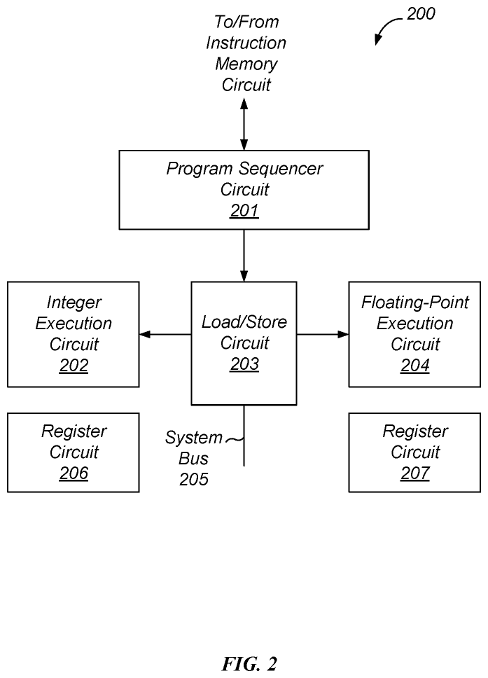

In various embodiments, program sequencer circuit 102 and execution circuits 103A and 103B may be included in a processor, processor core, or other suitable processor circuit. A block diagram of an embodiment of such a processor circuit is depicted in FIG. 2. As illustrated, processor circuit 200 includes program sequencer circuit 201, integer execution circuit 202, load/store circuit 203, floating-point execution circuit 204, and register circuits 206 and 207. In various embodiments, processor circuit 200 may correspond to a processor core that can be coupled to other processor cores to form a compute complex. In such cases, data can be exchanged between cores using system bus 205.

Program sequencer circuit 201 is configured to retrieve, on a per-cycle basis, a program or software instruction from an instruction memory circuit (e.g., instruction memory circuit 101) in a process referred to as “fetching an instruction.” In various embodiments, program sequencer circuit 201 may be configured to retrieve the program or software instruction across a multi-bit bus (e.g., 32-bits). Upon retrieving a particular instruction, program sequencer circuit 201 may be configured to decode the particular instruction and, based on results of the decode, route the particular instruction to one of integer execution circuit 202, load/store circuit 203, or floating-point execution circuit 204.

Integer execution circuit 202 is configured to receive arithmetic instructions from program sequencer circuit 201. In response to receiving a given arithmetic instruction from program sequencer circuit 201, integer execution circuit 202 is also configured to perform an arithmetic operation, or an integer multiply and divide operation, based on the given arithmetic instruction. In various embodiments, integer execution circuit 202 may be further configured to perform various logic (e.g., an exclusive-OR operation) and bit manipulation operations (e.g., a shift-left operation). In various embodiments, integer execution circuit 202 may correspond to one of execution circuits 103A or 103B as depicted in FIG. 1. As described below, integer execution circuit 202 may include multiple execution sub-circuits configured to execute respective instructions in parallel.

Load/Store circuit 203 is configured to load data from a data memory circuit or system bus 205 in response to receiving a load instruction from program sequencer circuit 201. Additionally, load/store circuit 203 may be further configured to store data to the data memory circuit or system bus 205 in response to receiving a store instruction from program sequencer circuit 201. In some cases, load/store circuit 203 may be configured to store data to or retrieve data from register circuits 206 and 207.

Floating-point execution circuit 204 may be configured to perform various floating-point arithmetic operations according to an instruction received from program sequencer circuit 201. As described below, floating-point execution circuit 204 may include multiple execution sub-circuits that are implemented with respective pipeline circuits. In some embodiments, floating-point execution circuit 204 may be configured to perform single-cycle instructions using an execution sub-circuit with a single-cycle pipeline. Floating-point execution circuit 204 may be further configured to perform various multi-cycle instructions (e.g., floating-point add, square root, etc.) using execution sub-circuits that include multi-cycle pipelines. In some embodiments, floating-point execution circuit 204 may be further configured to perform logarithmic, exponential, and other transcendental operations. In various embodiments, floating-point execution circuit 204 may correspond to one of execution circuits 103A or 103B.

Register circuits 206 and 207 are configured to store multiple results generated by integer execution circuit 202 and floating-point execution circuit 204. In various embodiments, information stored in register circuits 206 and 207 may include information pertaining to the architectural state of processor circuit 200. In some embodiments, integer execution circuit 202 and floating-point execution circuit 204 may be configured to read previously stored data from register circuits 206 and 207. Load/store circuit 203 may also be configured to store data into, or read data from, register circuits 206 and 207. In various embodiments, register circuits 206 and 207 may be implemented using multiple latch circuits, flip-flop circuits, or any other suitable storage circuits arranged in multiple rows. It is noted that, in some embodiments, only a single register circuit may be employed to store results from both integer execution circuit 202 and floating-point execution circuit 204.

It is noted that processor circuit 200 may include other circuit blocks which have been omitted from the embodiment of FIG. 2 for clarity.

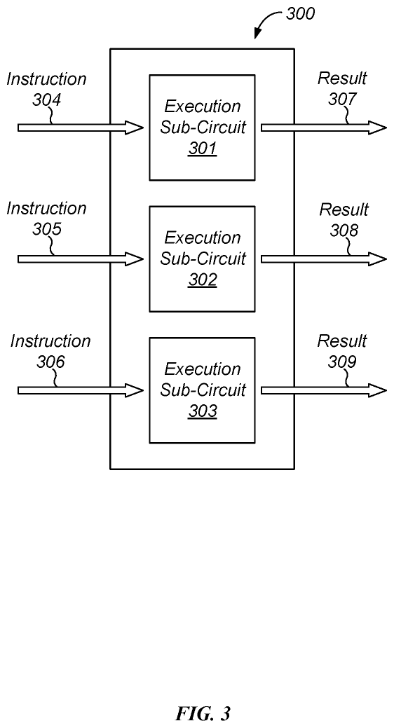

Turning to FIG. 3, a block diagram of an embodiment of an execution circuit is depicted. As illustrated, execution circuit 300 includes execution sub-circuits 301-303. In various embodiments, execution circuit 300 may correspond to either of execution circuits 103A or 103B as depicted in FIG. 1.

Execution sub-circuit 301 is configured to execute instruction 304 to generate result 307. In a similar fashion, execution sub-circuits 302 and 303 are configured to execute instructions 305 and 306, respectively, to generate results 308 and 309, respectively. Although only a single instruction is shown being issued to execution sub-circuits 302-303, in other embodiments, multiple instructions may be issued to execution sub-circuits 302-303 in a pipelined fashion. In various embodiments, any of execution sub-circuits 301-303 may use one or more operands in the execution of their respective instructions. Such operands may be read by execution sub-circuits 301-303 from register circuits such as register circuits 206 and 207 as depicted in FIG. 2.

In some embodiments, execution sub-circuits 301-303 may be implemented using a pipeline of multiple logic circuits. In some cases, respective lengths of the pipelines for execution sub-circuits 301-303 may be different to accommodate different multi-cycle instructions. In other embodiments, any of execution sub-circuits 301-303 may be configured to perform iterative instructions such as floating-point division or floating-point square root instructions, for example.

Although only three execution sub-circuits are depicted in the embodiment of FIG. 3, in other embodiments, any suitable number of execution sub-circuits may be employed.

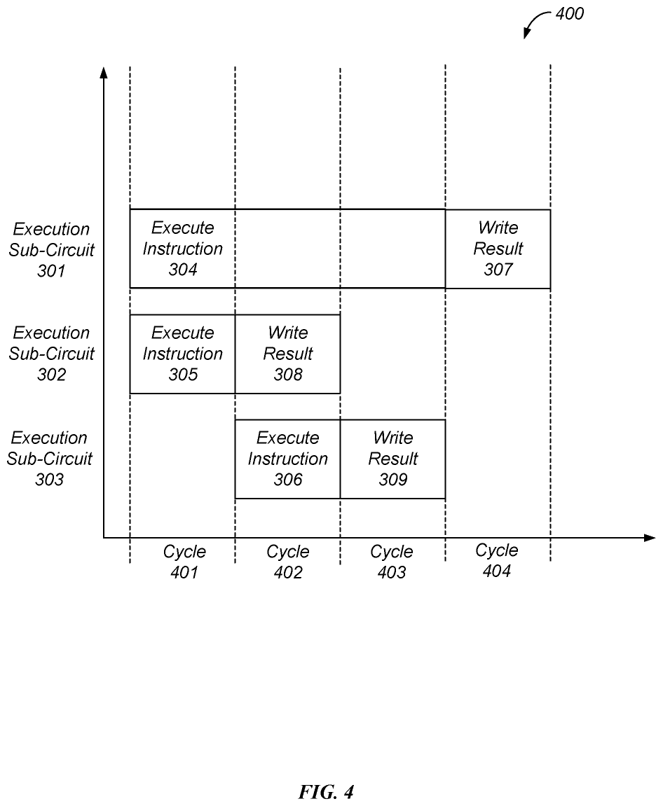

Turning to FIG. 4, a diagram depicting execution of different instructions across different execution sub-circuits included in a computer system that allows out-of-order completion is illustrated. Although the diagram depicts three execution sub-circuits executing corresponding instructions, in other embodiments, any suitable number of instructions may be executed in parallel using corresponding execution sub-circuits.

In cycle 401, execution sub-circuits 301 and 302 begin execution of instructions 304 and 305, respectively. It is noted that both instructions 304 and 305 are issued in the same cycle in a process called “multi-issue.” In various embodiments, any needed operands have been loaded into register circuits (e.g., register circuits 206 and 207), by a load/store circuit such as load/store circuit 203.

In cycle 402, the execution of instruction 304 continues as it is a multi-cycle instruction. Instruction 305, however, is a single-cycle instruction, so at the conclusion of cycle 401, result 308 is ready, which is written to its corresponding register during cycle 402. Instruction 306 is also issued in cycle 402.

In cycle 403, the execution of instruction 304 continues. Like instruction 305, instruction 306 is also a single-cycle instruction, with result 309 which is written to its corresponding register during cycle 403. In cycle 404, the execution of instruction 304 has finished and result 307 is written to its corresponding register.

Since hazards and dependencies have been previously checked, execution sub-circuits 301-303 are free to write results 307-309 to their designated register as soon as the execution of instructions 304-306 have finished. This allows for instructions 305 and 306 to be completed out-of-order with respect to instruction 304. Since results 308 and 309 can be written to their respective registers in an out-of-order fashion, there is no need to temporarily store results 308 and 309, thereby reducing the size of a reorder buffer circuit or possibly eliminating the need to the reorder buffer circuit entirely.

Instructions 304-306 may have been fetched from instruction memory circuit 101 in an order specified by a program or application to which the instructions belong. Program sequencer circuit 102 issues instructions 304-306 based on availability of execution sub-circuits 301-303, as well as any pending hazards. Instructions 304-306 are completed in an order based on when their respective results are ready. The completion order may, in various embodiments, be different from the order in which instructions 304-306 were issued. It is noted that although only four cycles are depicted in FIG. 4, in other embodiments, instructions using more than four cycles are possible and contemplated.

To summarize, various embodiments of a computer system are disclosed. Broadly speaking, an instruction memory circuit may be configured to store a plurality of instructions, while a program sequencer circuit may be configured to fetch the plurality of instructions from the instruction memory circuit in a program order. The program sequencer circuit may be further configured to issue a particular instruction to a particular execution circuit of a plurality of execution circuits in response to a determination that there are no hazards associated with the particular instruction. The particular execution circuit may be configured to complete the particular instruction prior to a completion of a different instruction of the plurality of instructions that was issued to a different execution circuit of the plurality of execution circuits prior to when the particular instruction was issued to the particular execution circuit. In some cases, to complete the particular instruction, the particular execution circuit may be further configured to write a result generated by executing the particular instruction to a particular register circuit of a plurality of register circuits. In various embodiments, the particular register circuit corresponds to the particular execution circuit.

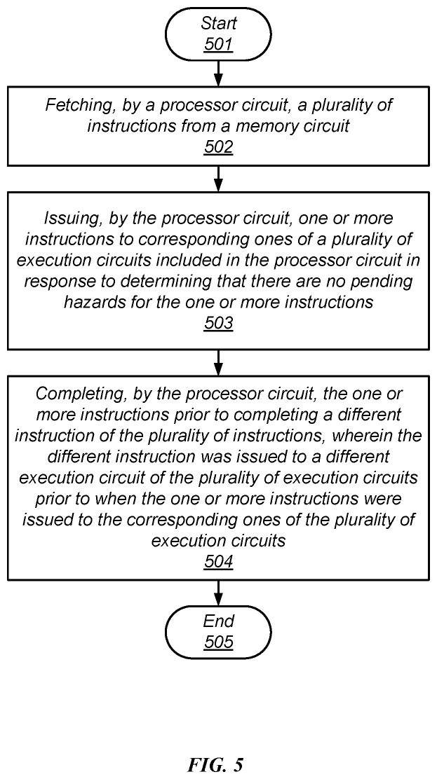

Turning to FIG. 5, a flow diagram depicting an embodiment of a method for operating a computer system is illustrated. The method, which may be applied to various computer systems, such as computer system 100, begins in block 501.

The method includes fetching, by a processor circuit, a plurality of instructions from a memory circuit (block 502). In various embodiments, fetching the plurality of instructions includes generating a first program counter value and fetching a first instruction of the plurality of instructions using the first program counter value. Additionally, fetching the plurality of instructions may also include generating a second program counter value that is different from the first program counter value, and fetching a second instruction of the plurality of instructions using the second program counter value.

The method further includes issuing, by the processor circuit, one or more instructions of the plurality of instructions to corresponding ones of a plurality of execution circuits included in the processor circuit in response to determining that there are no pending hazards for the particular instruction (block 503). In some embodiments, the method may also include, in response to fetching a given instruction of the plurality of instructions, performing a hazard check operation on the given instruction, and delaying issuing the given instruction using a result of the hazard check operation. In other embodiments, the method may further include delaying issuing the given instruction in response to determining that there is a read-after-write hazard associated with the given instruction.

In various embodiments, issuing the particular instruction may include performing a decode operation on the one or more instructions. In such cases, the method may further include selecting the corresponding ones of the plurality of execution circuits using a result of the decode operation.

The method also includes completing, by the processor circuit, the one or more instruction prior to completing a different instruction of the plurality of instructions, wherein the different instruction was issued to a different execution circuit of the plurality of execution circuits prior to when the one or more instructions were issued to the corresponding one of the plurality of execution circuits (block 504).

In some embodiments, a given execution circuit of the corresponding ones of the plurality of execution circuits may include a plurality of execution sub-circuits, and issuing the one or more instructions includes issuing a given instruction of the one or more instructions to a first execution sub-circuit of the plurality of execution sub-circuits. The method may also further include issuing, by the processor circuit, a particular instruction of the plurality of instructions to a second execution sub-circuit of the plurality of execution sub-circuits after issuing the given instruction to the first execution sub-circuit. Additionally, the method may include completing, by the processor circuit, the particular instruction prior to completing the given instruction.

In various embodiments, the processor circuit may include a plurality of register circuits corresponding to the plurality of execution circuits. In such cases, completing the one or more instructions includes writing, by the processor circuit, corresponding results generated by executing the one or more instructions to at least one register circuit of the plurality of register circuits. The method ends in block 505.

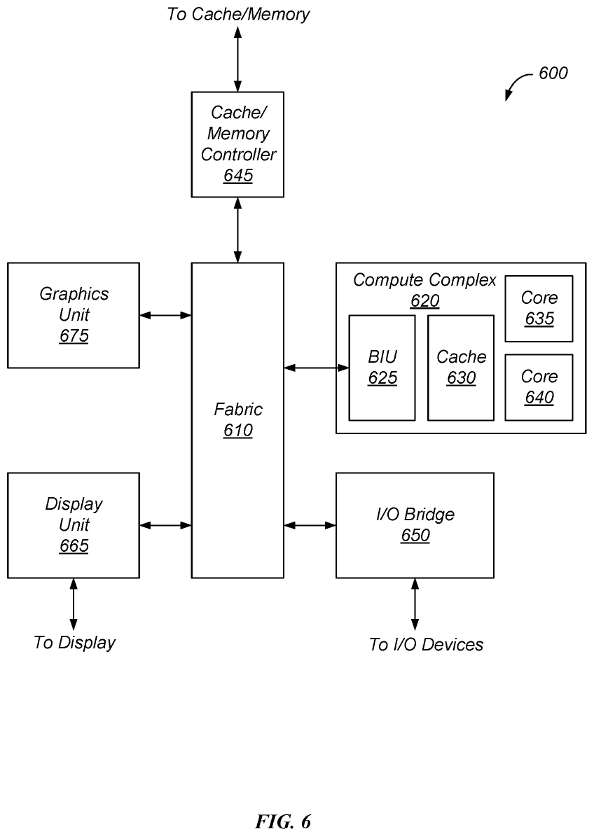

Referring now to FIG. 6, a block diagram illustrating an example embodiment of a device that includes a processor circuit that employs out-of-order completion is shown. In various embodiments, device 600 may implement functionality of program sequence circuit 102 and execution circuits 103A and 103B as depicted in FIG. 1. In some embodiments, elements of device 600 may be included within a system on a chip. In some embodiments, device 600 may be included in a mobile device, which may be battery-powered. Therefore, power consumption by device 600 may be an important design consideration. In the illustrated embodiment, device 600 includes fabric 610, compute complex 620, input/output (I/O) bridge 650, cache/memory controller 645, graphics unit 675, and display unit 665. In some embodiments, device 600 may include other components (not shown) in addition to, or in place of, the illustrated components, such as video processor encoders and decoders, image processing or recognition elements, computer vision elements, etc.

Fabric 610 may include various interconnects, buses, MUX's, controllers, etc., and may be configured to facilitate communication between various elements of device 600. In some embodiments, portions of fabric 610 may be configured to implement various different communication protocols. In other embodiments, fabric 610 may implement a single communication protocol, and elements coupled to fabric 610 may convert from the single communication protocol to other communication protocols internally.

In the illustrated embodiment, compute complex 620 includes bus interface unit (BIU) 625, cache 630, and cores 635 and 640. In various embodiments, compute complex 620 may include various numbers of processors, processor cores, and caches. For example, compute complex 620 may include 1, 2, or 4 processor cores, or any other suitable number. In one embodiment, cache 630 is a set associative L2 cache. In some embodiments, cores 635 and 640 may include internal instruction and data caches. In some embodiments, a coherency unit (not shown) in fabric 610, cache 630, or elsewhere in device 600 may be configured to maintain coherency between various caches of device 600. BIU 625 may be configured to manage communication between compute complex 620 and other elements of device 600. Processor cores such as cores 635 and 640 may be configured to execute instructions of a particular instruction set architecture (ISA) which may include operating system instructions and user application instructions. These instructions may be stored in a computer readable medium such as a memory coupled to cache memory controller 645 as discussed below.

As used herein, the term “coupled to” may indicate one or more connections between elements, and a coupling may include intervening elements. For example, in FIG. 6, graphics unit 675 may be described as “coupled to” a memory through fabric 610 and cache/memory controller 645. In contrast, in the illustrated embodiment of FIG. 6, graphics unit 675 is “directly coupled” to fabric 610 because there are no intervening elements.

Cache/memory controller 645 may be configured to manage transfer of data between fabric 610 and one or more caches and memories. For example, cache/memory controller 645 may be coupled to an L3 cache, which may, in turn, be coupled to a system memory. In other embodiments, cache/memory controller 645 may be directly coupled to a memory. In some embodiments, cache/memory controller 645 may include one or more internal caches. Memory coupled to cache/memory controller 645 may be any type of volatile memory, such as dynamic random access memory (DRAM), synchronous DRAM (SDRAM), double data rate (DDR, DDR2, DDR3, etc.), SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 645 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 620 to cause the computing device to perform functionality described herein.

Graphics unit 675 may include one or more processors, e.g., one or more graphics processing units (GPUs). Graphics unit 675 may receive graphics-oriented instructions, such as OPENGL®, Metal®, or DIRECT3D® instructions, for example. Graphics unit 675 may execute specialized GPU instructions or perform other operations based on the received graphics-oriented instructions. Graphics unit 675 may generally be configured to process large blocks of data in parallel, and may build images in a frame buffer for output to a display, which may be included in the device or may be a separate device. Graphics unit 675 may include transform, lighting, triangle, and rendering engines in one or more graphics processing pipelines. Graphics unit 675 may output pixel information for display images. Graphics unit 675, in various embodiments, may include programmable shader circuitry, which may include highly parallel execution cores configured to execute graphics programs, which may include pixel tasks, vertex tasks, and compute tasks (which may or may not be graphics-related).

Display unit 665 may be configured to read data from a frame buffer and provide a stream of pixel values for display. Display unit 665 may be configured as a display pipeline in some embodiments. Additionally, display unit 665 may be configured to blend multiple frames to produce an output frame. Further, display unit 665 may include one or more interfaces (e.g., MIPI® or embedded display port (eDP)) for coupling to a user display (e.g., a touchscreen or an external display).

I/O bridge 650 may include various elements configured to implement universal serial bus (USB) communications, security, audio, and low-power always-on functionality, for example. I/O bridge 650 may also include interfaces such as pulse-width modulation (PWM), general-purpose input/output (GPIO), serial peripheral interface (SPI), and inter-integrated circuit (I2C), for example. Various types of peripherals and devices may be coupled to device 600 via I/O bridge 650.

In some embodiments, device 600 includes network interface circuitry (not explicitly shown), which may be connected to fabric 610 or I/O bridge 650. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 600 with connectivity to various types of other devices and networks.

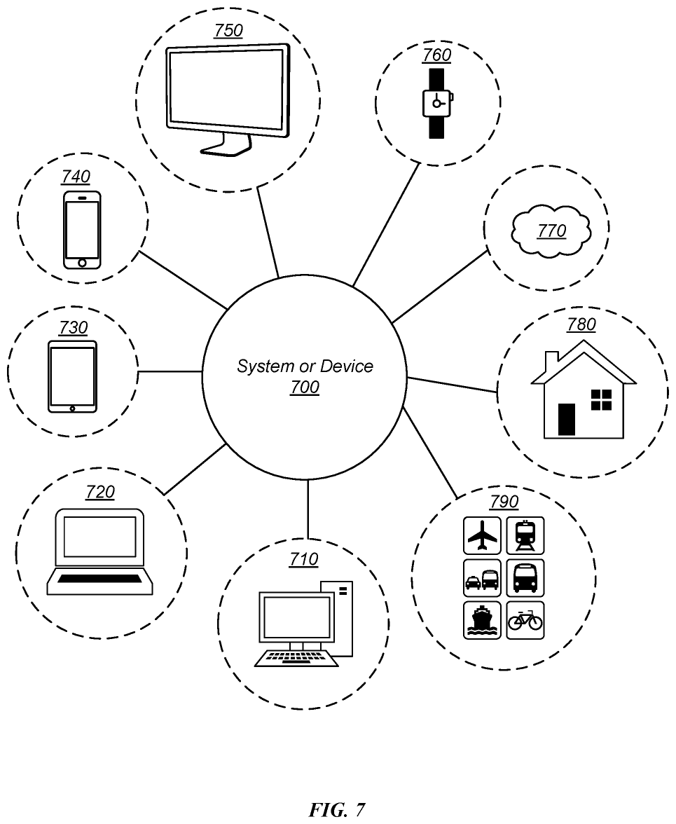

Turning now to FIG. 7, various types of systems that may include any of the circuits, devices, or systems discussed above are illustrated. System or device 700, which may incorporate or otherwise utilize one or more of the techniques described herein, may be utilized in a wide range of areas. For example, system or device 700 may be utilized as part of the hardware of systems such as a desktop computer 710, laptop computer 720, tablet computer 730, cellular or mobile phone 740, or television 750 (or set-top box coupled to a television).

Similarly, disclosed elements may be utilized in a wearable device 760, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 700 may also be used in various other contexts. For example, system or device 700 may be utilized in the context of a server computer system, such as a dedicated server or on shared hardware that implements a cloud-based service 770. Still further, system or device 700 may be implemented in a wide range of specialized everyday devices, including devices 780 commonly found in the home such as refrigerators, thermostats, security cameras, etc. The interconnection of such devices is often referred to as the “Internet of Things” (IoT). Elements may also be implemented in various modes of transportation. For example, system or device 700 could be employed in the control systems, guidance systems, entertainment systems, etc. of various types of vehicles 790.

The applications illustrated in FIG. 7 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

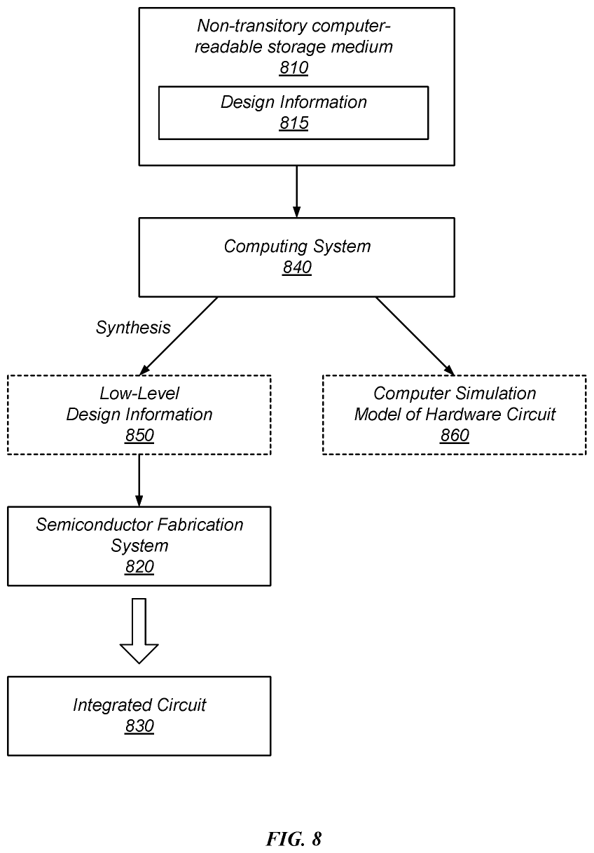

FIG. 8 is a block diagram illustrating an example of a non-transitory computer-readable storage medium. As illustrated, non-transitory computer-readable storage medium 810 is configured to store design information 815, according to some embodiments. In the illustrated embodiment, computing system 840 is configured to process design information 815. This may include executing instructions included in design information 815, interpreting instructions included in design information 815, compiling, transforming, or otherwise updating design information 815, etc. Therefore, design information 815 controls computing system 840 (e.g., by programming computing system 840) to perform various operations discussed below, in some embodiments.

In the illustrated example, computing system 840 processes design information 815 to generate both computer simulation model of hardware circuit 860 and low-level design information 850. In other embodiments, computing system 840 may generate only one of these outputs, may generate other outputs based on design information 815, or both. Regarding computer simulation model of hardware circuit 860, computing system 840 may execute instructions of a hardware description language that includes register transfer level (RTL) code, behavioral code, structural code, or some combination thereof. The simulation model may perform the functionality specified by design information 815, facilitate verification of the functional correctness of the hardware design, generate power consumption estimates, generate timing estimates, etc.

In the illustrated example, computing system 840 also processes design information 815 to generate low-level design information 850 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 850 (potentially among other inputs), semiconductor fabrication system 820 is configured to fabricate integrated circuit 830 (which may correspond to functionality of the computer simulation model of hardware circuit 860). Note that computing system 840 may generate different simulation models based on design information 815 at various levels of description, including low-level design information 850, computer simulation model of hardware circuit 860, and so on. The data representing low-level design information 850 and computer simulation model of hardware circuit 860 may be stored on non-transitory computer readable storage medium 810, or on one or more other media.

In some embodiments, low-level design information 850 controls (e.g., programs) semiconductor fabrication system 820 to fabricate integrated circuit 830. Thus, when processed by the fabrication system, the design information may program the fabrication system to fabricate a circuit that includes various circuitry disclosed herein.

Non-transitory computer-readable storage medium 810 may comprise any of various appropriate types of memory devices or storage devices. Non-transitory computer-readable storage medium 810 may be an installation medium, e.g., a CD-ROM, floppy disks, or a tape device; a computer system memory or random access memory such as DRAM, DDR RAM, SRAM, EDO RAM, Rambus RAM, etc.; a non-volatile memory such as Flash memory circuits, magnetic media, e.g., a hard drive, or optical storage; registers, or other similar types of memory elements, etc. Non-transitory computer-readable storage medium 810 may include other types of non-transitory memory as well or combinations thereof. Accordingly, non-transitory computer-readable storage medium 810 may include two or more memory media, which may reside in different locations—for example, in different computer systems that are connected over a network.

Design information 815 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 840, semiconductor fabrication system 820, or both. In some embodiments, design information 815 may also include one or more cell libraries that specify the synthesis, layout, or both, of integrated circuit 830. In some embodiments, design information 815 is specified in whole, or in part, in the form of a netlist that specifies cell library elements and their connectivity. Design information discussed herein, taken alone, may or may not include sufficient information for fabrication of a corresponding integrated circuit. For example, design information may specify the circuit elements to be fabricated, but not their physical layout. In this case, design information may be combined with layout information to actually fabricate the specified circuitry.

Integrated circuit 830 may, in various embodiments, include one or more custom macrocells, such as memories, analog or mixed-signal circuits, and the like. In such cases, design information 815 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 820 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 820 may also be configured to perform various testing of fabricated circuits for correct operation.

In various embodiments, integrated circuit 830 and computer simulation model of hardware circuit 860 are configured to operate according to a circuit design specified by design information 815, which may include performing any of the functionality described herein. For example, integrated circuit 830 may include any of various elements shown in FIG. 1. Further, integrated circuit 830 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 815. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 815 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 850. Low-level design information 850 may program semiconductor fabrication system 820 to fabricate integrated circuit 830.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third.” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
an instruction memory circuit configured to store a plurality of instructions;
a plurality of execution circuits; and
a program sequencer circuit configured to:
fetch the plurality of instructions from the instruction memory circuit in a program order; and
issue a particular instruction to a particular execution circuit in response to a determination that there are no hazards associated with the particular instruction; and
wherein the particular execution circuit is configured to complete the particular instruction prior to a completion of a different instruction of the plurality of instructions that was issued to a different execution circuit of the plurality of execution circuits prior to when the particular instruction was issued to the particular execution circuit.

2. The apparatus of claim 1, further comprising a plurality of register circuits corresponding to the plurality of execution circuits and, wherein to complete the particular instruction, the particular execution circuit is further configured to write a result generated by executing the particular instruction to a particular register circuit of the plurality of register circuits corresponding to the particular execution circuit.

3. The apparatus of claim 1, wherein the program sequencer circuit is further configured to delay issuing a given instruction of the plurality of instructions in response to a determination that the given instruction has at least one associated hazard.

4. The apparatus of claim 3, wherein the at least one associated hazard includes a read-after-write hazard.

5. The apparatus of claim 1, wherein the particular execution circuit includes a plurality of execution sub-circuits, wherein to issue the particular instruction, the program sequencer circuit is further configured to issue the particular instruction to a first execution sub-circuit of the plurality of execution sub-circuits, and wherein the program sequencer circuit is further configured to issue a given instruction of the plurality of instructions to a second execution sub-circuit of the plurality of executions sub-circuits prior to issuing the particular instruction, and wherein the second execution sub-circuit is configured to complete the given instruction prior to a completion of the particular instruction.

6. The apparatus of claim 1, wherein to issue the particular instruction, the program sequencer circuit is further configured to:
perform a decode operation on the particular instruction; and
select the particular execution circuit from the plurality of execution circuits using a result of the decode operation.

7. A method, comprising:
fetching, by a processor circuit, a plurality of instructions from a memory circuit;
issuing, by the processor circuit, one or more instructions of the plurality of instructions to corresponding ones of a plurality of execution circuits included in the processor circuit in response to determining there are no pending hazards for the one or more instructions; and
completing, by the processor circuit, the one or more instructions prior to completing a different instruction of the plurality of instructions, wherein the different instruction was issued to a different execution circuit of the plurality of execution circuits prior to when the one or more instructions were issued to the corresponding ones of the plurality of execution circuits.

8. The method of claim 7, wherein the processor circuit further includes a plurality of register circuits corresponding to the plurality of execution circuits, and wherein completing the one or more instructions includes writing, by the processor circuit, corresponding results generated by executing the one or more instructions to at least one register circuit of the plurality of register circuits.

9. The method of claim 7, wherein a given execution circuit of the corresponding ones of the plurality of execution circuits includes a plurality of execution sub-circuits, and wherein issuing the one or more instructions includes issuing a given instruction of the one or more instructions to a first execution sub-circuit of the plurality of execution sub-circuits.

10. The method of claim 9, further comprising:
issuing, by the processor circuit, a particular instruction of the plurality of instructions to a second sub-execution circuit of the plurality of execution sub-circuits after issuing the given instruction to the first execution sub-circuit; and
completing, by the processor circuit, the particular instruction prior to completing the given instruction.

11. The method of claim 7, further comprising:
in response to fetching a given instruction of the plurality of instructions, performing a hazard check operation on the given instruction; and
delaying issuing the given instruction using a result of the hazard check operation.

12. The method of claim 11, further comprising delaying issuing the given instruction in response to determining that there is a read-after-write hazard associated with the given instruction.

13. The method of claim 7, wherein issuing the one or more instructions includes:
performing a decode operation on the one or more instructions; and
selecting the corresponding ones of the plurality of execution circuits using a result of the decode operation.

14. An apparatus, comprising:
a memory circuit configured to store a plurality of instructions; and
a plurality of processor cores including a particular processor core configured to:
fetch the plurality of instructions from the memory circuit;
issue, to a particular execution circuit of a plurality of execution circuits included in the particular processor core, a particular instruction of the plurality of instructions in response to determining that there are no pending hazards for the particular instruction; and
complete the particular instruction prior to completing a different instruction of the plurality of instructions, wherein the different instruction was issued to a different execution circuit of the plurality of execution circuits prior to when the particular instruction was issued to the particular execution circuit.

15. The apparatus of claim 14, wherein the particular processor core further includes a plurality of register circuits corresponding to the plurality of execution circuits, and wherein to complete the particular instruction, the particular processor core is further configured to write a result generated by executing the particular instruction to a particular register circuit of the plurality of register circuits corresponding to the particular execution circuit.

16. The apparatus of claim 14, wherein the particular execution circuit includes a plurality of execution sub-circuits, and wherein to issue the particular instruction, the particular processor core is further configured to issue the particular instruction to a first execution sub-circuit of the plurality of execution sub-circuits.

17. The apparatus of claim 16, wherein the particular processor core is further configured to:
issue a given instruction of the plurality of instructions to a second execution sub-circuit of the plurality of execution sub-circuits after issuing the particular instruction to the first execution sub-circuit; and
complete the given instruction prior to completing the particular instruction.

18. The apparatus of claim 14, wherein the particular processor core is further configured to:
in response to fetching a given instruction of the plurality of instructions, perform a hazard check operation on the given instruction; and
delay issuing the given instruction using a result of the hazard check operation.

19. The apparatus of claim 18, wherein the particular processor core is further configured to delay issuing the given instruction in response to a determination that there is a read-after-write hazard associated with the given instruction.

20. The apparatus of claim 14, wherein to issue the particular instruction, the particular processor core is further configured to:
perform a decode operation on the particular instruction; and
select the particular execution circuit from the plurality of execution circuits using a result of the decode operation.
